(19) United States
(12) Patent Application Publication
(10) Pub. No.: US 2011/0149832 A1
(43) Pub. Date: Jun. 23, 2011

(54) METHOD FOR DATA TRANSMITTING IN MOBILE MULTICAST BROADCAST SERVICE

(75) Inventors: Eunkyung KIM, Seoul (KR); Jae Sun CHA, Daejeon-si (KR); Soojung JUNG, Daejeon-si (KR); Sung Cheol CHANG, Daejeon-si (KR); Kwang Jae LIM, Daejeon-si (KR); Hyun LEE, Daejeon-si (KR); Chul Sik YOON, Seoul (KR)

(73) Assignee: Electronics and Telecommunications Research Institute, Daejeon-si (KR)

(21) Appl. No.: 12/977,463

(22) Filed: Dec. 23, 2010

(30) Foreign Application Priority Data
Dec. 23, 2009 (KR) 10-2009-0129479
Dec. 23, 2010 (KR) 10-2010-0133193

(51) Int. Cl. H04H 20/71

(52) U.S. Cl. 370/312

(57) ABSTRACT

Disclosed is a method for transmitting multicast broadcast service (MBS) data in a wireless communication system, the method comprising: transmitting an MBS MAP, which comprises MBS AAI subframe offset and MBS resource index. MBS AAI subframe offset and MBS resource index indicate the end subframe (i.e., subframe offset) of MBS data and the number of resource units in the end subframe of the MBS data burst and resource allocation information about an MBS data burst, to a mobile station; and allocating resources as many as the number of resource units which is appointed by the MBS subframe offset and MBS resource index from transmission starting point of the MBS data burst on the basis of the resource allocation information and transmitting the MBS data burst using the allocated resources to the mobile station

### CROSS-REFERENCE TO RELATED APPLICATIONS

This application claims the benefit of priority of Korean Patent Application No. 10-2009-0129479 Dec. 23, 2009 and Korean Patent Application No. 10-2010-0133193 filed on Dec. 23, 2010, which are incorporated by reference in their entirety herein.

### BACKGROUND OF THE INVENTION

1. Field of the invention

The present invention relates to a multicast broadcast service (MBS) in a mobile wireless connection system, and more particularly, to a method for transmitting MBS data in consideration of resource allocation.

2. Related Art

3GPP (3rd Generation Partnership Project) LTE (long term evolution) and IEEE (Institute of Electrical and Electronics Engineers) 802.16m have been developed as a candidate for the next-generation wireless communication system. The 802.16m standard has two aspects, modification from the existing 802.16e standards as continuity from the past and standards for the next-generation international mobile telecommunications (IMT)-Advanced system as continuity to the future. Accordingly, the 802.16m standard has to not only keep compatibility with a mobile WiMAX system based on the 802.16e standard but also satisfy all advanced requirements for the IMT-Advanced system.

The wireless communication system generally uses one bandwidth for transmitting data. For example, a second-generation wireless communication system uses a bandwidth of 200 KHz˜1.25 MHz, and a third-generation wireless communication system uses a bandwidth of 5 MHz˜10 MHz. To support increased transmission capacity, the 3GPP LTE or 802.16m has recently continued to increase the bandwidth up to 20 MHz or higher. The increase of the bandwidth is necessary for increasing the transmission capacity, but it may cause high power consumption if supporting a broad bandwidth even when a required service level is low.

The IEEE 802.16m system supports an enhanced multicast broadcast service (E-MBS). The E-MBS is a point-to-multipoint system in which data packets are simultaneously transmitted from one source to a plurality of destinations. Broadcast means capability for transmitting contents to all users. Multicast means contents directed to a certain group of users subscribed to receive a certain service. Static multicast and dynamic multicast may be supported.

However, there is a need for a method of efficiently transmitting an MBS MAP and an MBS data burst even though the MBS MAP and the MBS data burst are transmitted over two or more subframes or frames.

### SUMMARY OF THE INVENTION

The present invention is to make a BS and a MS efficiently and set up and accurately manage an MBS in a wireless communication system.

In an aspect, there is provided a method for transmitting multicast broadcast service (MBS) data in a wireless communication system , the method comprising: transmitting an MBS MAP, which comprises MBS AAI subframe offset and MBS resource index. MBS AAI subframe offset and MBS resource index indicate the end subframe (i.e., subframe offset) of MBS data and the number of resource units in the end subframe of MBS data burst and resource allocation information about an MBS data burst, to a mobile station; and allocating resources as many as the number of resource units which is appointed by the MBS subframe offset and MBS resource index from transmission starting point of the MBS data burst on the basis of the resource allocation information and transmitting the MBS data burst using the allocated resources to the mobile station

A first subframe of a first frame at each superframe may be allocated for superframe header, and wherein the transmission starting point of the MBS data burst may be second subframe of the first frame.

The transmission starting point of the MBS data burst may be the point which MBS MAP transmission ends.

The MBS MAP also may include a burst extension indicator for indicating whether the MBS data burst is transmitted over a plurality of consecutive subframes, and wherein if the burst extension indicator indicates that the MB S data burst is transmitted over the plurality of consecutive subframes, the MBS data burst is transmitted using respective predetermined resource regions on the plurality of consecutive subframes.

Each of the plurality of consecutive subframes may comprise a flag, and the flag indicates whether the respective predetermined resource regions are the same even in the following subframe.

The respective predetermined resource regions may be different in position and size according to the plurality of consecutive subframes.

The respective predetermined resource regions may have the same position and size according to the plurality of consecutive subframes.

The resource allocation information may comprise a position and size of a predetermined resource region of a subframe having the first temporal priority among the plurality of consecutive subframes.

The MBS MAP may comprise the number of consecutive subframes.

In another aspect, there is provided a method for transmitting multicast broadcast service (MBS) data in a wireless communication system , the method comprising: transmitting an MBS configuration message, which comprises resource allocation information about an MBS MAP and MBS MAP resource index indicating the number of resource units transmitting from transmission starting point of the MBS MAP, transmitting the MBS MAP using to the mobile station on the basis of the resource allocation information and the MAP extension indicator; and allocating resources as many as the number of resource units which is appointed by the MBS MAP resource index from transmission starting point of the MBS MAP on the basis of the resource allocation information and transmitting the MBS MAP using the allocated resources to the mobile station; and transmitting an MBS data burst to the mobile station on the basis of the MBS MAP.

If the MAP extension indicator indicates that the MBS MAP is transmitted over the plurality of consecutive subframes, the MBS MAP may be transmitted using respective predetermined resource regions on the plurality of consecutive subframes.

Each of the plurality of consecutive subframes may comprise a flag, and the flag indicates whether the respective predetermined resource regions are the same even in the following subframe.

The respective predetermined resource regions may be different in position and size according to the plurality of consecutive subframes.

A predetermined resource region of one subframe among the plurality of consecutive subframes may be different in position and size from predetermined resource regions of the other subframes.

The respective predetermined resource regions may have the same position and size according to the plurality of consecutive subframes.

Respective predetermined resource regions of inner subframes excluding the first subframe and the last subframe among the plurality of consecutive subframes correspond to a whole frequency domain allocated to the mobile station.

The resource allocation information may comprise a position and size of a predetermined resource region of a subframe having the first temporal priority among the plurality of consecutive subframes.

The MBS configuration message may comprise the number of consecutive subframes.

In accordance with the present invention, when an MBS MAP or an MBS data burst is transmitted for an MBS, efficient and accurate operations are possible even though the MBS MAP or the MBS data burst is transmitted over a plurality of subframes.

### BRIEF DESCRIPTION OF THE DRAWINGS

FIG. 1 shows a wireless communication system.

FIG. 2 is a flowchart showing an MBS-data transmitting method in which a base station transmits an MBS data burst to a mobile station.

FIG. 3 illustrates an example of transmitting the MBS data by allocating MBS region according to an exemplary embodiment of the present invention.

FIG. 4 illustrates another example of transmitting the MBS data by allocating MBS region according to an exemplary embodiment of the present invention.

FIG. 5 illustrates an example of transmitting the MBS data burst using a predetermined resource region on the plurality of consecutive subframes according to an exemplary embodiment of the present invention.

FIG. 6 illustrates another example of transmitting the MBS data burst using a predetermined resource region on the plurality of consecutive subframes according to an exemplary embodiment of the present invention.

FIG. 7 is a flowchart showing an MBS-data transmitting method in which a base station transmits an MBS data burst to a mobile station by transmitting an MBS MAP.

FIG. 8 illustrates an example of an MBS-data transmitting method in which a base station transmits an MBS data burst to a mobile station by transmitting an MBS MAP.

FIG. 9 is other example of an MBS-data transmitting method in which a base station transmits an MBS data burst to a mobile station by transmitting an MBS MAP.

FIG. 10 is an example of an MBS resource allocation according to an exemplary embodiment of the present invention.

FIG. 11 is another example of an MBS resource allocation according to an exemplary embodiment of the present invention.

### DESCRIPTION OF EXEMPLARY EMBODIMENTS

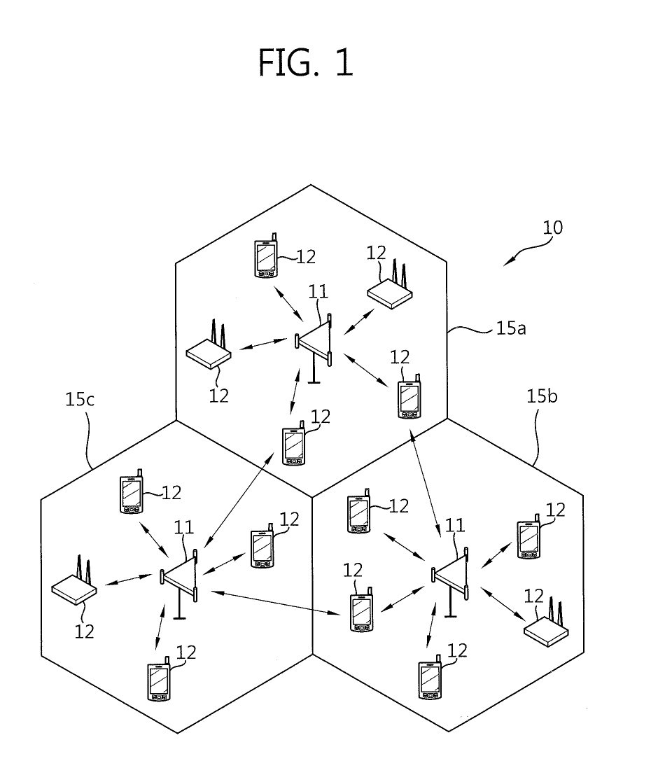

FIG. 1 shows a wireless communication system. Referring to FIG. 1, a wireless communication system 10 includes at least one base station (BS) 11. Each BS 11 provides a communication service to a specific geographical region (or generally called a cell) 15a, 15b, 15c. Also, the call may be divided again into a plurality of regions (or called a sector). A mobile station (MS) 12 may be stationary or movable, and may also be called in other terms such as user equipment (UE), a mobile terminal (MT), a subscriber station (SS), a wireless device, a personal digital assistant (PDA), a wireless modem, a handheld device, etc. The BS 11 generally refers to a fixed station that communicates with the MS 12, and may also be called in other terms such as evolved-NodeB (eNB), a base transceiver system (BTS), an access point, etc. Below, downlink refers to communication from the BS 11 to the MS 12, and uplink refers to communication from the MS 12 to the BS 11. In the downlink, a transmitter is a part of the BS 11, and a receiver is a part of the MS 12. In the uplink, a transmitter is a part of the MS 12, and a receiver is a part of the BS 11. Further, a packet flow of the uplink or downlink between the BS 11 and the MS 12 is called a service flow.

A frame refers to a data sequence of a fixed period of time used by a physical specification. The radio frame is configured with a unit of superframe, and one superframe is divided into four frames. Further, each frame is divided into a plurality of subframes. The first subframe of each superframe includes a primary superframe header (P-SFH), and may periodically include a secondary superframe header (S-SFH).

In a method where unicast data and multicast broadcast service (MBS) data are divisionally transmitted by time division multiplexing (TDM), a certain subframe is allocated for transmitting the MBS data (i.e., to an MBS region). And, in a method where unicast data and multicast broadcast service data are divisionally transmitted by frequency division multiplexing(FDM), a subframe is allocated for transmitting the MBS data (i.e., to an MBS region) in units of frequencies.

The transmitting format and size of the MBS data is informed through a message of an MBS MAP, and the MBS MAP message mostly defines connection to downlink information (which may include uplink information) in the subframe. The MBS MAP may be included in every subframe through which the MBS data is carried, or may be periodically included. The position of the MBS MAP is informed by the S-SFH, and the next position of the MBS MAP is informed in the MBS MAP. Thus, mobile stations (MS) starting the MBS operate in such a way as to receive the MBS data by ascertaining the position of the first MBS MAP on the basis of the S-SFH, and since then go to the next MBS MAP by receiving the MBS MAP without referring to the S-SFH.

The MBS MAP may be transmitted in a previously defined position (e.g., in a start subframe of a region allocated for the MBS at a starting position of MBS scheduling interval (MSI), and at this time the mobile station does not have to be informed of the position of the corresponding MBS MAP. However, the first subframe of the first frame of every superframe is excluded from the region allocated for the MBS since it is allocated for a superframe header.

The mobile station receives an MBS configuration message for the MBS. The MBS configuration message may include information about the MBS MAP to define transmission characteristics of an MBS data burst. For example, the MBS configuration message may include information such as the number of MBS zones, MBS zone identification (ID), MSI, an MBS MAP resource index, an MBS MAP Isizeoffset, an MBS MAP multi input multi output (MIMO) mode, etc.

In the MBS configuration message, the MBS MAP defining the transmission characteristics defines the characteristics of the MBS data burst transmitted for providing the MBS. The MBS MAP includes information such as the number of streams, stream ID, Isizeoffset, an MIMO mode for MBS data burst, a frame/subframe offset, a resource index, an allocation period, etc.

The MBS MAP is indicated through the MBS configuration message, and the mobile station can access a corresponding resource indicated through the MBS MAP. Unnecessary data decoding can be prevented by accessing a stream corresponding to a content of the MBS through the MBS MAP.

Information about the MBS MAP is acquired through the MBS configuration message, and a corresponding MBS data burst is received by acquiring information about a stream corresponding to a content on the basis of the received MBS MAP, thereby performing decoding. Such configuration information may be included in a certain control channel, a media access control (MAC) header, another configuration message, etc. as well as the MBS configuration message. In the following exemplary embodiment, the configuration information is included in the MBS configuration message and the MBS MAP, but not limited thereto.

Also, this method may be used in not only transmitting the MBS data, but also transmitting general data and representing a zone of a message/control channel or the like.

Below, it will be described that the MBS MAP or the MBS data burst is transmitted over the plurality of subframes. Here, the MBS MAP or the MBS data burst may be transmitted over the plurality of frames, which conforms to the same methods as being transmitted over the plurality of subframes. Thus, the following descriptions with regard to the subframes are nothing but an example, and there is no limit even though only the transmission over the plurality of subframes is described.

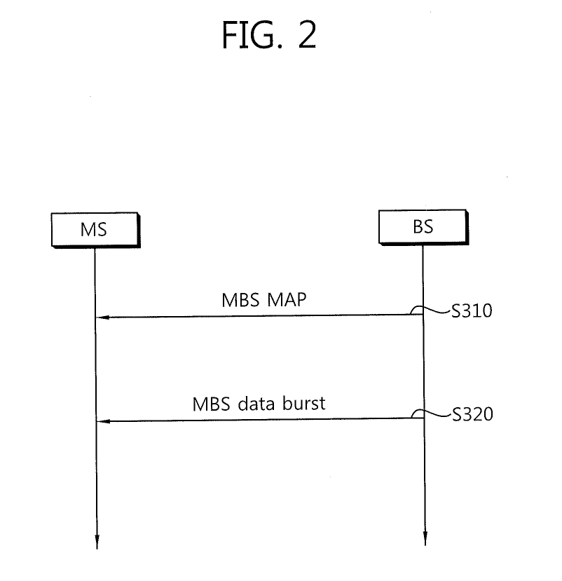

FIG. 2 is a flowchart showing an MBS-data transmitting method in which a base station transmits an MBS data burst to a mobile station.

Referring to FIG. 2, the base station transmits an MBS MAP to the mobile station (S310). The MBS MAP includes resource allocation information about the MBS data burst, thereby defining an MBS data burst. For example, the resource allocation information refers to subframe offset and resource index or the like, and may include the position and size for resource allocation.

Here, the allocation of resources for MBS (including MBS MAP and MBS data burst) is allocated in the region for MBS (i.e., MBS region), and, the first subframe of first frame of each superframe is the region which is allocated for superframe header. So Resource allocation is done in downlink subframe of the MBS region, excluding said subframe of MBS region.

Then, the base station transmits the MBS data burst to the mobile station on the basis of the resource allocation information (S320). Besides the resource allocation information, the MBS MAP may include information about the number of subframes through which the MBS data burst is transmitted. The foregoing information helps to determine a region to which the MBS data burst is transmitted.

At this time, MBS MAP(or MBS data burst or MBS data information elements) may include MBS AAI subframe offset and MBS resource index. MBS AAI subframe offset is the index of the AAI subframe where the MBS data burst ends and the offset index begins at the beginning of the MSI. MBS resource index is a index for indication of a point which MBS data burst ends, and is represented by the number of resource unit (e.g., as an index of SLRU).

As long as the start point of allocation MBS resource is especially appointed, MBS resource for MBS data burst may be allocated right after MBS MAP is transmitted in MBS region. Therefore, without appointing the start point of MBS resource allocation especially, MBS data may be transmitted by allocating MBS resource based on the number of resource unit of MBS region subframe which is appointed by MBS subframe offset and MBS resource index.

Whether the MBS data burst is transmitted to a single subframe is analogized from the number of resource units. If the number of resource unit is too big to transmit to a single subframe, the MBS MAP may be transmitted over the plurality of consecutive subframes.

Also, MBS MAP(or MBS data burst or MBS data information elements) may have MBS subframe offset. MBS subframe offset indicates the subframe which MBS data burst ends. Last part of the subframe which MBS subframe offset indicates may be indicated by MBS resource index

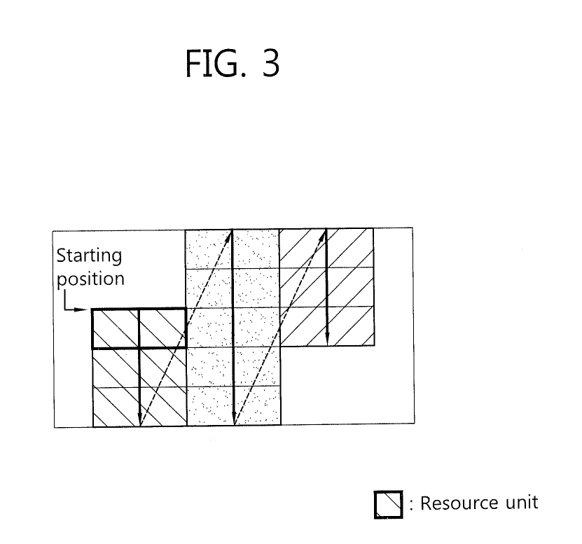

FIG. 3 illustrates an example of transmitting the MBS data by allocating MBS region according to an exemplary embodiment of the present invention.

Referring to FIG. 3, on the basis of start point, that is, transmission starting point of MBS data burst, resource is allocated by region as many as the number of resource units(11 in FIG. 3) which is appointed by MBS subframe offset and MBS resource index. MBS data burst is transmitted by allocated resource.

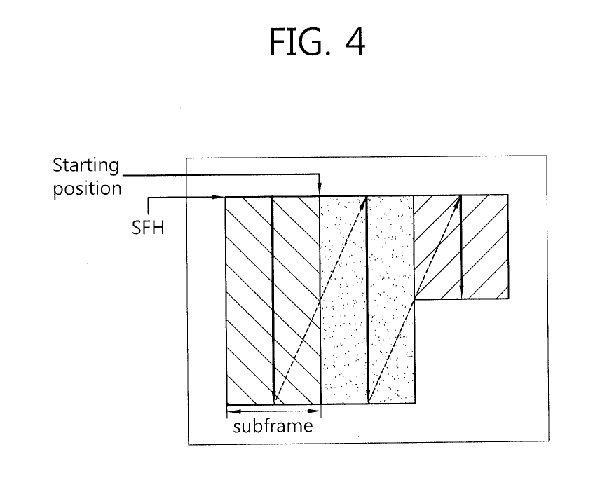

FIG. 4 illustrates another example of transmitting the MBS data by allocating MBS region according to an exemplary embodiment of the present invention. Referring to FIG. 4, if not especially appointed, the starting point of transmission of MBS data burst may be second subframe of first frame. Because, the first subframe of first frame is allocated for SuperFrame Header.

By the way, the starting point of transmission of MBS data burst may be the point which MBS MAP ends, or the point which previous MBS data burst ends. Or, the starting point of transmission of MBS data burst may be the starting point of MBS scheduling interval.

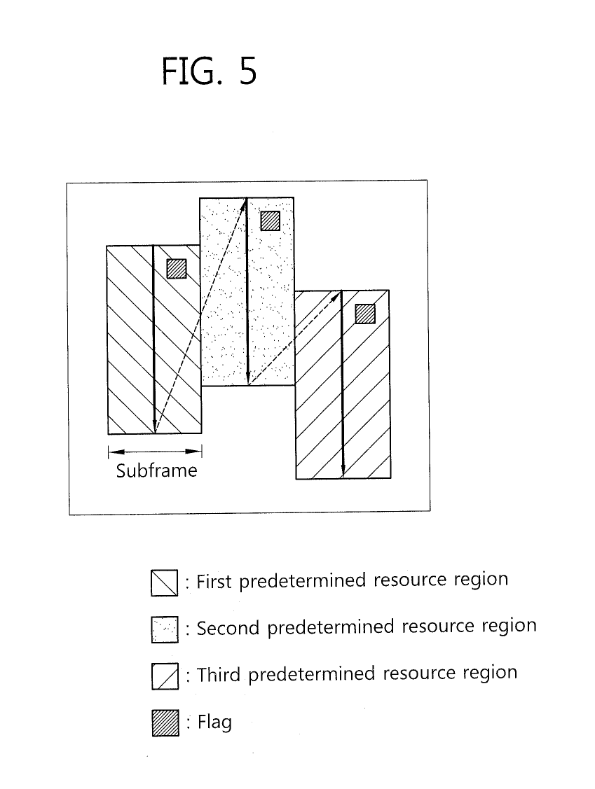

FIG. 5 illustrates an example of transmitting the MBS data burst using a predetermined resource region on the plurality of consecutive subframes according to an exemplary embodiment of the present invention.

Referring to FIG. 5, the MBS data burst may be transmitted over the plurality of consecutive subframes as indicated by the burst extension indicator which indicate whether MBS data burst is transmitted. At this time, the MBS data burst may be transmitted by allocating a predetermined resource region to each subframe. The MBS data burst starting in a first predetermined resource region is transmitted in an arrow direction over second and third predetermined resource regions. The burst extension indicator refers to an indicator that indicates whether the MBS data burst is transmitted over the plurality of consecutive subframes.

If the predetermined resource regions are different in position and size according to the plurality of consecutive subframes, it is possible to allocate the predetermined resource regions by respectively informing the resource regions.

Each predetermined resource region may include an indicator in the form of a flag. A relevant indicator (i.e., a flag) indicates whether each predetermined resource region is the same even in the following subframe.

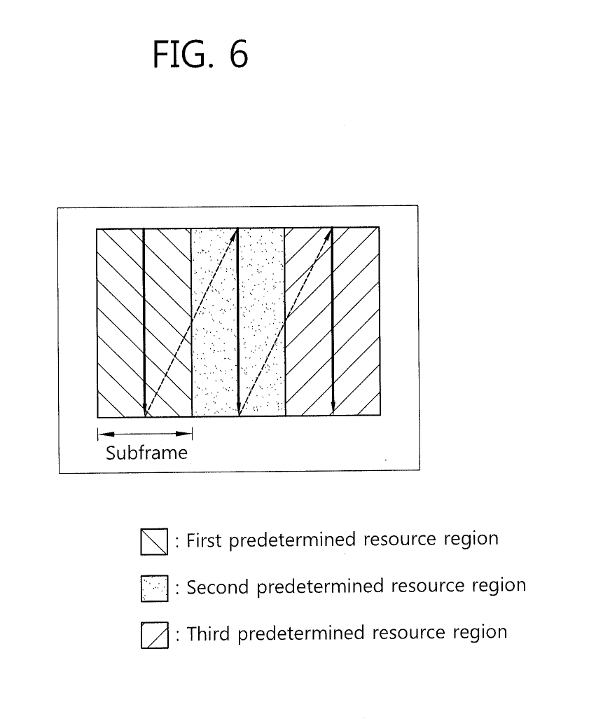

FIG. 6 illustrates another example of transmitting the MBS data burst using a predetermined resource region on the plurality of consecutive subframes according to an exemplary embodiment of the present invention.

As indicated by the flag, the respective predetermined resource regions of the subframes are the same. The respective predetermined resource regions have the same position and size with regard to the plurality of consecutive subframes. Like this, in the case that the respective predetermined resource regions have the same position and size with regard to the plurality of consecutive subframes, if the position and size of the predetermined resource region of the subframe having the first temporal priority are informed, there is no need for being repetitively informed of the position and size of the following predetermined resource regions since the same position and size are applied to the following predetermined resource regions.

Below, it will be described that the MBS MAP is transmitted over the plurality of consecutive subframes.

As the MBS data burst is transmitted over the plurality of consecutive subframes, the MBS MAP may also be transmitted over the plurality of consecutive subframes.

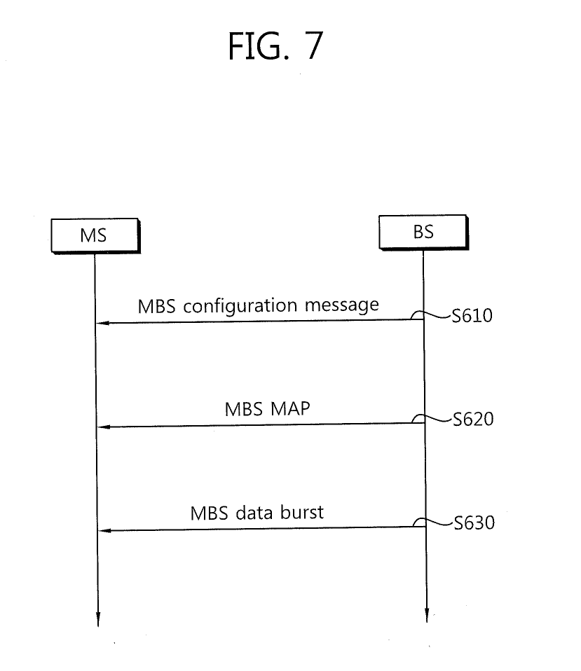

FIG. 7 is a flowchart showing an MBS-data transmitting method in which a base station transmits an MBS data burst to a mobile station by transmitting an MBS MAP.

Referring to FIG. 7, the base station transmits an MBS configuration message containing resource allocation information of the MBS MAP to the mobile station (S610). The MBS configuration message includes not only the resource allocation information about the MBS MAP but also MBS MAP resource index which appoint the number of resource units which is transmitted from MBS MAP transmission starting point and an MAP extension indicator indicating whether the MBS MAP is transmitted over the plurality of consecutive subframes. The base station allocates resources as may as the number of resource units which MBS MAP resource index appoint from MBS MAP transmission starting point on the basis of the resource allocation information and transmits the MBS MAP to the mobile station using the allocated resource (S620). The is MBS data bust is transmitted to the mobile station on the basis of the MBS MAP (S630). In this case, the MBS MAP is transmitted over the plurality of consecutive subframes as the MBS data burst is transmitted over the plurality of consecutive subframes, in which approximately the same physical method is used for allocating resources.

MBS MAP resource index is a index which indicates the point which MBS MAP ends, and is represented by the number of resource units.

As long as the point which MBS MAP resource allocation start is specially appointed, MBS MAP resource is allocated from second subframe of first frame. So, without appointing the starting point of MBS MAP resource allocation, MBS MAP may be transmitted by allocating MBS MAP resource on the basis of the number of resource units of MBS region subframe which is appointed by MBS MAP resource index. Because, the first subframe of first frame is allocated for SFH.

Whether the MBS MAP is transmitted to a single subframe is analogized from the number of resource units. If the number of resource unit is too big to transmit to a single subframe, the MBS MAP may be transmitted over the plurality of consecutive subframes.

By the way, the start point of MBS data burst transmission may be the point which previous MBS data burst ends or the point which MBS scheduling interval starts.

Like the burst extension, the MAP extension indicator indicates whether the MBS MAP is transmitted over the plurality of consecutive subframes. In addition to the resource allocation information, the MBS configuration message may further include information about the number of consecutive subframes where the MBS MAP is transmitted, and the information helps to determine a region to which the MBS MAP is transmitted.

As indicated by the MAP extension indicator, the MBS MAP may be transmitted over the plurality of consecutive subframes. At this time, the MBS MAP may be transmitted by allocating predetermined resource regions to the subframes, respectively. The MBS MAP starting in a first predetermined resource region is transmitted in an arrow direction over second and third predetermined resource regions.

Each predetermined resource region may include an indicator in the form of a flag. A relevant indicator (i.e., a flag) indicates whether each predetermined resource region is the same even in the following subframe. Also, the flag may inform the subframe including the flag and the following subframe whether they are transmitted to the same resource region or different resource regions. If the transmission has the same characteristic, it is possible to omit transmission information.

As indicated by the flag, the predetermined resource regions of the subframes where the MBS MAP is transmitted are the same. The respective predetermined resource regions have the same position and size with regard to the plurality of consecutive subframes.

Also, in the case that the respective predetermined resource regions have the same position and size with regard to the plurality of consecutive subframes, if the position and size of the predetermined resource region of the subframe having the first temporal priority are informed, it is possible to omit the positions and sizes of the following predetermined resource regions since the same position and size are applied to the following predetermined resource regions.

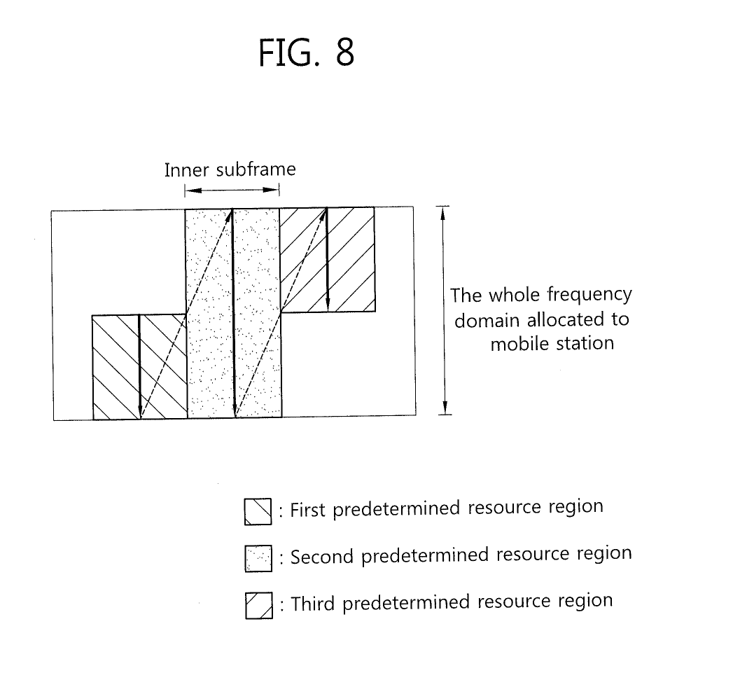

FIG. 8 illustrates an example of an MBS-data transmitting method in which a base station transmits an MBS data burst to a mobile station by transmitting an MBS MAP. Referring to FIG. 8, respective predetermined resource regions are regarded as the whole frequency domain allocated to the mobile station with regard to inner subframes excluding the first subframe and the last subframe. In this case, on the basis of the first-allocated resource allocation position, the transmission is possible by sequential extension base on the resource allocation size after the relevant subframe.

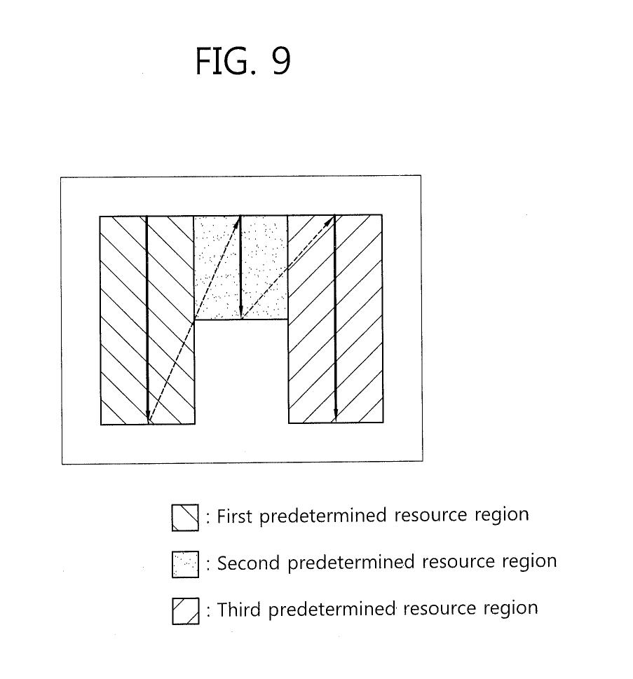

FIG. 9 is other example of an MBS-data transmitting method in which a base station transmits an MBS data burst to a mobile station by transmitting an MBS MAP.

Referring to FIG. 9, the position and size of the predetermined resource region to which the resource is allocated are the same except the position and size of the predetermined resource region of any one of the subframes.

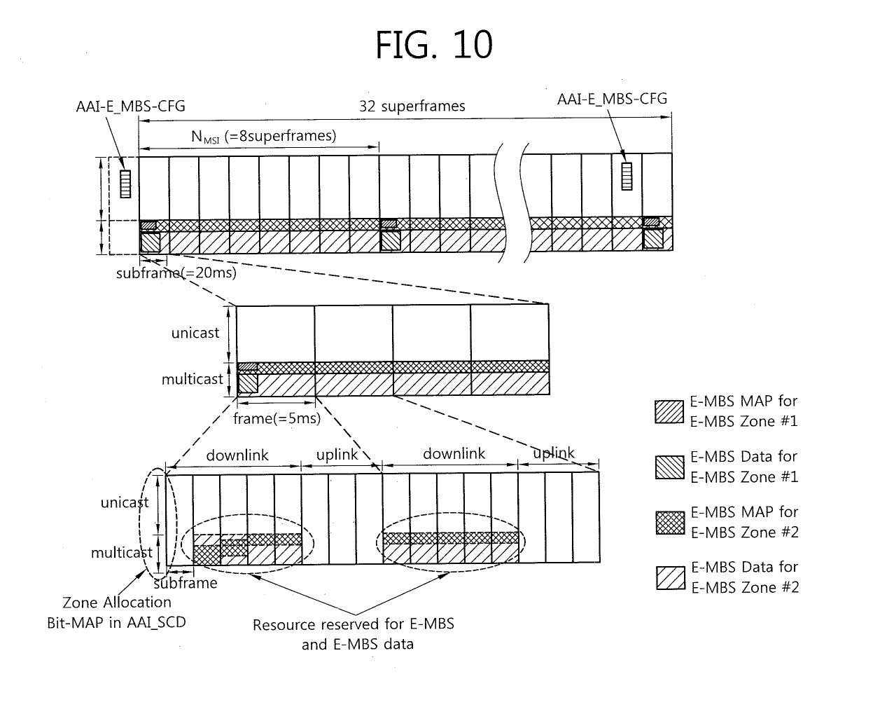

FIG. 10 is an example of an MBS resource allocation according to an exemplary embodiment of the present invention.

Referring to FIG. 10, in a single frame, unicast/multicast are divided by FDM method. In a multicast region(E-MBS region), those are divided and allocated by FDM method in each E-MBS zone.

Looking the chateristic of data for MBS, MBS configuration message(AAI_E-MBS-CFG) define transmission point and charateristic of MBS MAP of every MBS zones which is supported in carriers. Its position may be a superframe that the remainings of number of superframe by dividing 32 is 31.

MBS MAP(or E-MBS MAP) defines transmission point and charateristic of MBS data burst. Because it exists independently in every zones, only one MBS MAP is transmitted in one MBS scheduling interval(MSI). Its position may be the first of MSI.

In the case of MBS data burst, only burst of one channel of one zone in one MSI is transmitted. Its position may be in order after MBS MAP is transmitted.

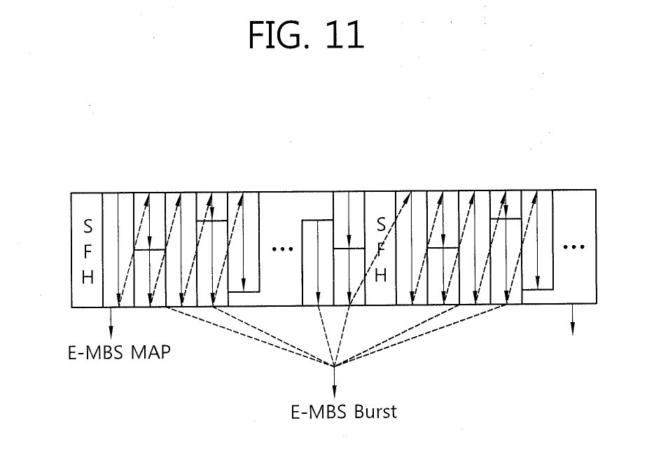

FIG. 11 is another example of an MBS resource allocation according to an exemplary embodiment of the present invention.

Referring to FIG. 11, MBS data burst is received contiously according to an exemplary embodiment of the present invention after receiving MBS MAP. First, SFH is received. And, MBS MAP is received. And, MBS data burst are allocated and received over a plurality of subframes.

In the foregoing exemplary embodiment, the methods were explained on the basis of a flowchart as a series of steps or blocks, but not limited to the above order of the steps. One step may be performed with regard to another step in different order or simultaneously. Also, it will be appreciated by those skilled in the art that the steps shown in the flowchart are not exclusive, other steps may be added, or one or more steps may be deleted from the flowchart without affecting the scope of the present invention.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for transmitting multicast broadcast service (MBS) data in a wireless communication system, the method comprising:
transmitting an MBS MAP, which comprises MBS resource index indicating the number of resource units transmitting from transmission starting point of MBS data burst and resource allocation information about an MBS data burst, to a mobile station; and
allocating resources as many as the number of resource units which is appointed by the MBS resource index from transmission starting point of the MBS data burst on the basis of the resource allocation information and transmitting the MBS data burst using the allocated resources to the mobile station.

2. The method of claim 1, wherein a first subframe of a first frame is allocated for superframe header, and
wherein the transmission starting point of the MBS data burst is second subframe of the first frame.

3. The method of claim 1, wherein the transmission starting point of the MBS data burst is the point which MBS MAP transmission ends.

4. The method of claim 1, wherein the transmission starting point of the MBS data burst is the point which previous MBS data burst transmission ends.

5. The method of claim 1, wherein the MBS MAP also includes a burst extension indicator for indicating whether the MBS data burst is transmitted over a plurality of consecutive subframes, and
wherein if the burst extension indicator indicates that the MBS data burst is transmitted over the plurality of consecutive subframes, the MBS data burst is transmitted using respective predetermined resource regions on the plurality of consecutive subframes.

6. The method of claim 5, wherein each of the plurality of consecutive subframes comprises a flag, and the flag indicates whether the respective predetermined resource regions are the same even in the following subframe.

7. The method of claim 5, wherein the respective predetermined resource regions to are different in position and size according to the plurality of consecutive subframes.

8. The method of claim 5, wherein the respective predetermined resource regions have the same position and size according to the plurality of consecutive subframes.

9. The method of claim 5, wherein the resource allocation information comprises a position and size of a predetermined resource region of a subframe having the first temporal priority among the plurality of consecutive subframes.

10. The method of claim 5, wherein the MBS MAP comprises the number of consecutive subframes.

11. A method for transmitting multicast broadcast service (MBS) data in a wireless communication system , the method comprising:
transmitting an MBS configuration message, which comprises resource allocation information about an MBS MAP and MBS MAP resource index indicating the number of resource units transmitting from transmission starting point of the MBS MAP,
transmitting the MBS MAP using to the mobile station on the basis of the resource allocation information and the MAP extension indicator; and
allocating resources as many as the number of resource units which is appointed by the MBS MAP resource index from transmission starting point of the MBS MAP on the basis of the resource allocation information and transmitting the MBS MAP using the allocated resources to the mobile station; and
transmitting an MBS data burst to the mobile station on the basis of the MBS MAP.

12. The method of claim 11, wherein if the MAP extension indicator indicates that the MBS MAP is transmitted over the plurality of consecutive subframes, the MBS MAP is transmitted using respective predetermined resource regions on the plurality of consecutive subframes.

13. The method of claim 12, wherein each of the plurality of consecutive subframes comprises a flag, and the flag indicates whether the respective predetermined resource regions are the same even in the following subframe.

14. The method of claim 12, wherein the respective predetermined resource regions are different in position and size according to the plurality of consecutive subframes.

15. The method of claim 12, wherein a predetermined resource region of one subframe among the plurality of consecutive subframes is different in position and size from predetermined resource regions of the other subframes.

16. The method of claim 12, wherein the respective predetermined resource regions have the same position and size according to the plurality of consecutive subframes.

17. The method of claim 12, wherein respective predetermined resource regions of inner subframes excluding the first subframe and the last subframe among the plurality of consecutive subframes correspond to a whole frequency domain allocated to the mobile station.

18. The method of claim 12, wherein the resource allocation information comprises a position and size of a predetermined resource region of a subframe having the first temporal priority among the plurality of consecutive subframes.

19. The method of claim 12, wherein the MBS configuration message comprises the number of consecutive subframes.
